(19) United States
(12) Patent Application Publication
(10) Pub. No.: US 2004/0010924 A1
(43) Pub. Date: Jan. 22, 2004

(54) Foldable scissors

(76) Inventors: Shen-Chi Hung, Taichung (TW); Sheng-Tsai Lee, Taipei (TW)

Correspondence Address: Mr. Charles E. Baxley, 5th Floor, 59 John Street, New York, NY, 10038, US

(21) Appl. No.: 10/199,716

(22) Filed: Jul. 22, 2002

(51) Int. Cl. B26B 13/00

(52) U.S. Cl. 30/255; 30/143; 30/151

(57) ABSTRACT

A foldable pair of scissors includes a first scissor, a second scissor pivotally connected with the first scissor, a first lever pivotally connected with the first scissor, a second lever pivotally connected with the second scissor, a first handle pivotally connected with the first lever and a second handle pivotally connected with the second lever. The foldable pair of scissors may include a retaining device for retaining each of the first and second handles in an extended position relative to one of the first and second levers. The retaining device may be a strip including an end secured to a side plate of the first or second handle and a free end for abutment against an end of a side strip of the first or second lever. The end of the side strip of the first or second lever may be flat for adequate engagement with the retaining device.

### BACKGROUND OF THE INVENTION

1. Field of Invention

The present invention relates to a foldable pair of scissors.

2. Related Prior Art

Taiwan Patent Publication No. 370771 discloses a foldable pair of multi-functional gardening scissors. The pair includes scissors 20 and 22 pivotally connected with each other. A handle 12 includes a first end with which the scissor 20 is pivotally connected and a second end with which a plurality of tools are connected. Similarly, a handle 14 includes a first end with which the scissor 22 is pivotally connected and a second end with which a plurality of tools are connected. The handles 12 and 14 both include two side strips and a back strip formed between the side strips. Thus, a space is defined between the side strips of each of the handles 12 and 14. Each of the side strips of each of the handles 12 and 14 includes a free edge. When not in use, the scissors 20 and 22 and the tools are concealed in the handles 12 and 14. When in use, the handles 12 and 14 are pivoted from the scissors 20 and 22. Thus, the scissors 20 and 22 are exposed for use. A user holds the handles 12 and 14 for operating the scissors 20 and 22. However, the free edges of the handles 12 and 14 cause an un-easy feel for the user, particularly when he or she exerts a large force on the handles 12 and 14. The handles 12 and 14 both fail to provide a sufficient length regarding leverage.

The present invention is therefore intended to obviate or at least alleviate the problems encountered in prior art.

### SUMMARY OF THE INVENTION

It is an objective of the present invention to provide a foldable pair of scissors that provides an easy feel for a user.

It is another objective of the present invention to provide a foldable pair of scissors that provides a sufficient length regarding leverage.

According to the present invention, a foldable pair of scissors includes a first scissor, a second scissor pivotally connected with the first scissor, a first lever pivotally connected with the first scissor, a second lever pivotally connected with the second scissor, a first handle pivotally connected with the first lever and a second handle pivotally connected with the second lever.

The foldable pair of scissors may include a retaining device for retaining each of the first and second handles in an extended position relative to one of the first and second levers. The retaining device may be a strip including an end secured to a side plate of the first or second handle and a free end for abutment against an end of a side strip of the first or second lever. The end of the side strip of the first or second lever may be flat for adequate engagement with the retaining device.

The foldable pair of scissors may include an elastic element compressed between the first and second scissors. The elastic element may be a helical spring. The first scissor may include an extension received in an end of the helical spring. The second scissor may include an extension received in an opposite end of the helical spring.

The first or second scissor may include a first shoulder formed thereon. The second or first scissor includes a locking device pivotally linked thereto for abutment against the first shoulder, thus locking the first and second scissors in a closed position.

Each of the first and second scissors may include a second shoulder formed thereon. Each of the first and second levers may include two side strips and a back strip formed between the side strips. The back strip may include an end for abutment against the second shoulder.

Other objects, advantages, and novel features of the invention will become more apparent from the following detailed description when taken in conjunction with the attached drawings.

### BRIEF DESCRIPTION OF THE DRAWINGS

The present invention will be described through detailed illustration of embodiments referring to the attached drawings wherein:

FIG. 1 is a perspective view of a foldable pair of scissors according to the present invention;

FIG. 2 is a cross-sectional view of the foldable pair of scissors according to the present invention;

FIG. 3 is a cross-sectional view of a portion of the foldable pair of scissors according to the present invention taken along a line 3-3 in FIG. 1;

FIG. 4 is similar to FIG. 2 and shows the foldable pair of scissors in a second position according to the present invention;

FIG. 5 is a cross-sectional view of a portion of the foldable pair of scissors according to the present invention taken along a line 5-5 in FIG. 4;

FIG. 6 is a side view of the foldable pair of scissors according to the present invention; and

FIG. 7 is a side view of the foldable pair of scissors in an idle position according to the present invention.

### DETAILED DESCRIPTION OF THE PREFERRED EMBODIMENT

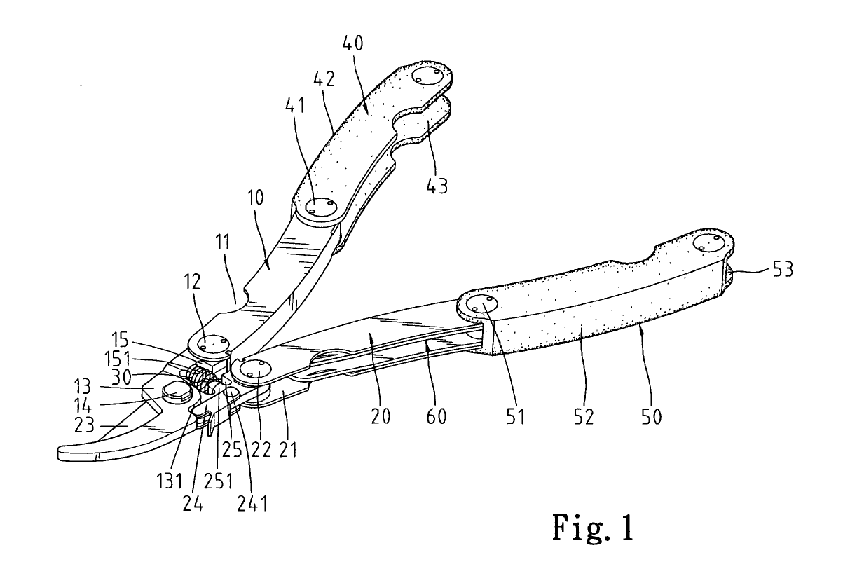

FIG. 1 shows a foldable pair of scissors according to the present invention. The pair includes a first scissor 13 and a second scissor 23. The scissors 13 and 23 are pivotally connected with each other via a shaft 14. The first scissor 13 is formed with a concave edge 15 from which a protrusion 151 extends. The second scissor 23 is formed with a concave edge 25 from which a protrusion 251 extends. A spring 30 includes a first end mounted on the protrusion 151 and a second end mounted on the protrusion 251. The first scissor 13 is formed with a shoulder 131.

A strut 24 is pivotally linked to the second scissor 23 by means of a shaft 241. The strut 24 can be pivoted between a locking position and a releasing position. In the locking position, the strut 24 is engaged with the shoulder 131 for locking the scissors 13 and 23 in a closed position.

The pair includes a first lever 10 and a second lever 20. The first lever 10 is linked to the first scissor 13 via a shaft 12. The second lever 20 is linked to the second scissor 23 via a shaft 22. Each of the levers 10 and 20 includes two side strips and a back strip formed between the side strips. A space 11 is defined between the side strips of the first lever 10 in order to receive the first scissor 13. A space 21 is defined between the side strips of the second lever 20 in order to receive the second scissor 23.

The first scissor 13 is formed with a shoulder 132 near the shaft 12. The back strip of the first lever 10 includes an end 17 for abutment against the shoulder 132 so as to retain the first lever 10 in a proper extended position relative to the first scissor 13 in operation. An identical shoulder is formed on the second scissor 23 for engagement against an end of the back strip of the second lever 20.

Referring to FIGS. 1˜3, the pair includes a first handle 40 and a second handle 50. The first handle 40 consists of a bone pivotally connected with the first lever 10 and a skin mounted on the bone. The bone is used for providing a sufficient strength, and is generally made of metal. The skin is used for providing an easy feel for a user, and is generally made of plastic or metal with a finished face 42. Similarly, the second handle 50 includes a bone and a skin. The bone of the first handle 40 is pivotally connected with the first lever 10 via a shaft 41. The bone of the second handle 50 is pivotally connected with the second scissor 20 via a shaft 51. The bone of each of the handles 40 and 50 includes two side strips and a back strip formed between the side strips. A space 43 is defined between the side strips of the bone of the first handle 40 in order to receive the first lever 10. A space 53 is defined between the side strips of the bone of the second handle 50 in order to receive the second lever 20.

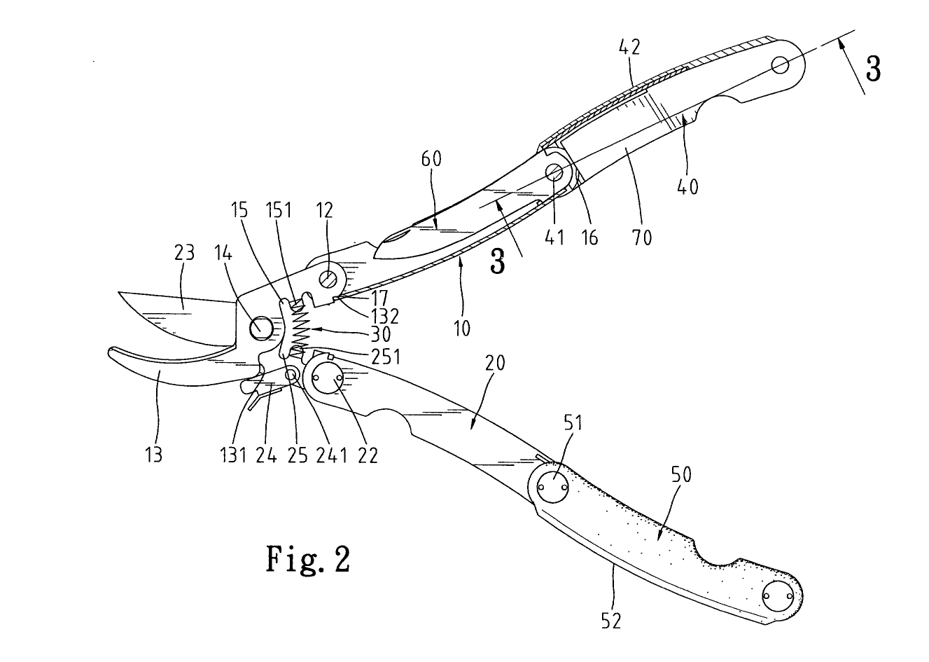

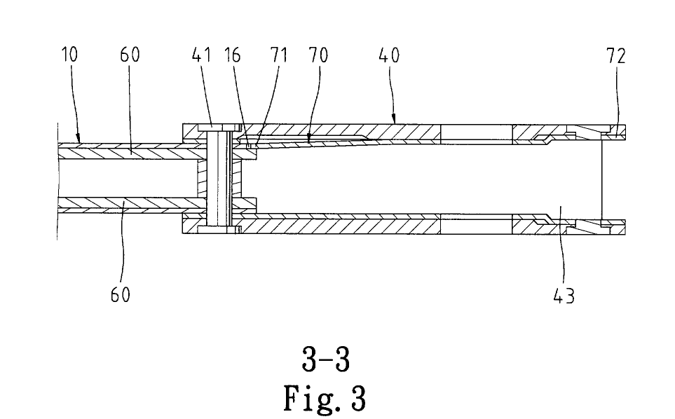

Referring to FIGS. 2 and 3, a retaining device 70 for retaining the first handle 40 in an extended position relative to the first lever 10 will be described. Although not shown, a retaining device identical to the retaining device 70 is used to retain the first handle 50 in an extended position relative to the second lever 20. The retaining device 70 is a metal strip extending from a side strip of the bone of the first handle 40. The retaining device 70 includes a free end 71. The retaining device 70 can be replaced with a leaf spring including an end secured to the side strip of the bone of the first handle 40 and a free end. In the extended position of the first handle 40 relative to the first lever 10, the retaining device 70 pivots from the skin of the first handle 40. Thus, the free end 71 of the retaining device 70 abuts an end 16 of one of the side strips of the first lever 10 so as to retain the extended position of the first handle 40 relative to the first lever 10. The end 16 of one of the side strips of the first lever 10 may be flat for better abutment against the free end 71 of the retaining device 70.

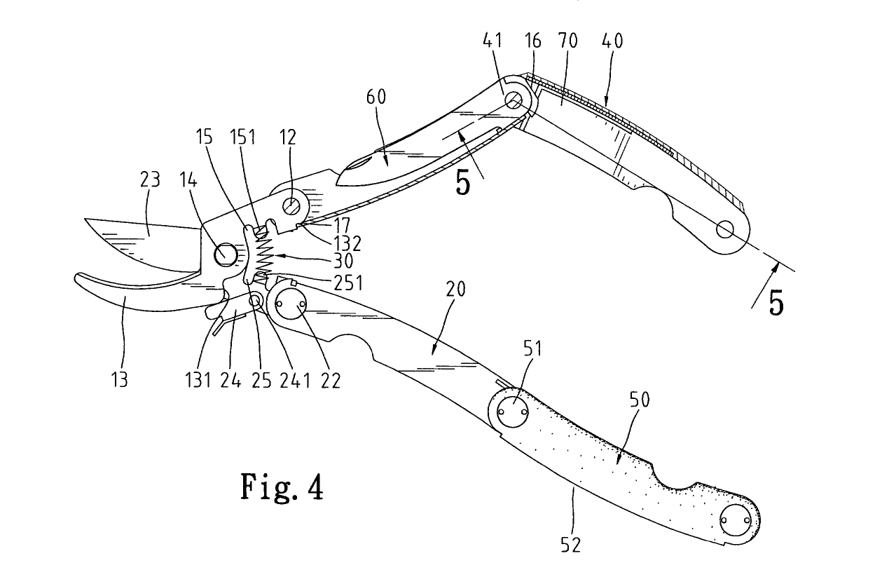

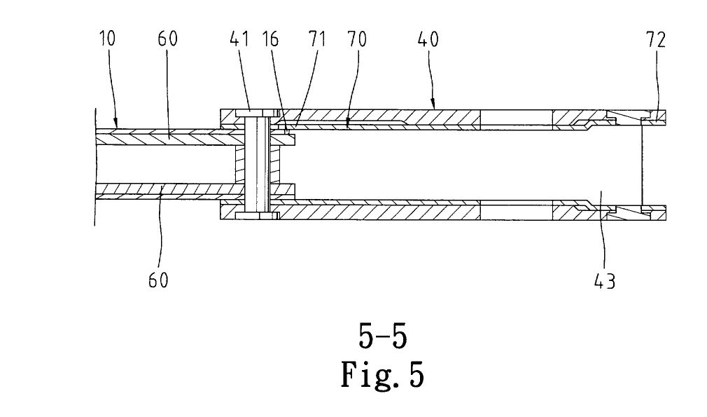

Referring to FIGS. 4 and 5, the retaining device 70 can be pressed against the skin of the first handle 40, thus allowing pivoting of the first handle 40 relative to the first lever 10.

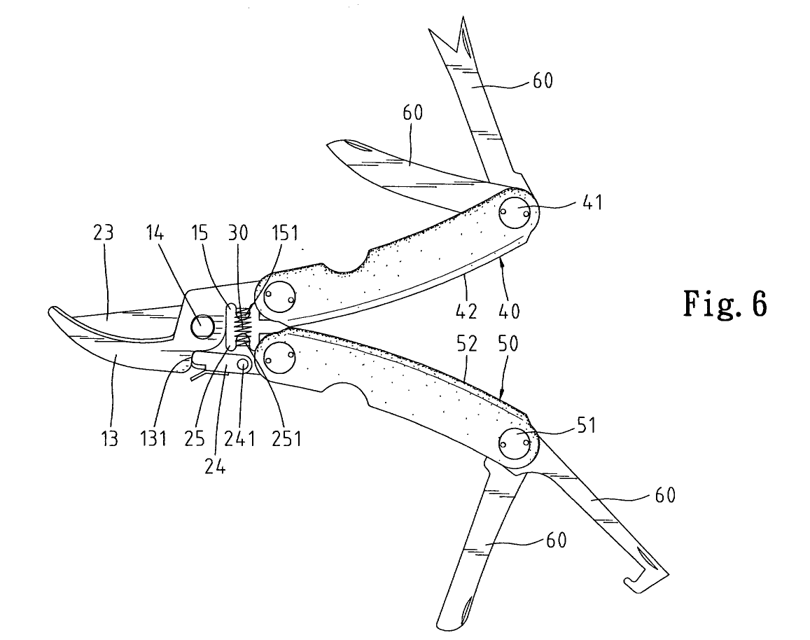

As best shown in FIG. 6, several tools 60 are pivotally linked to the first lever 10 and they can be received in the space 11. Several other tools 60 are pivotally linked to the second lever 20 and can be received in the space 21. Each of the tools 60 can be pivoted from the space 11 or 21 independent upon the other tools 60. Although given identical numbers, the tools are generally different in structure and function.

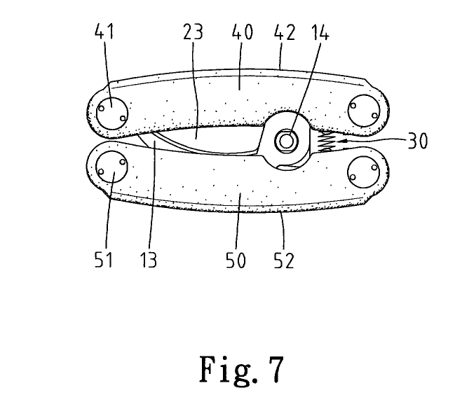

FIG. 7 shows the foldable pair of scissors in an idle position where the handles 40 and 50 are respectively folded relative to levers 10 and 20 that are respectively folded relative to the scissors 13 and 23.

In the present invention, the shafts can be configured in the form of a bolt, pivot or rivet so that they can be retained on their positions.

The cover of the first handle 40 and the cover of the second handle 50 provide an easy feel for a user in operation of the foldable pair of scissors according to the present invention. The use of first lever 10 and the second lever 20 in addition to the first handle 40 and the second handle 50 provides a sufficient length regarding leverage.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A foldable pair of scissors including a first scissor (13), a second scissor (23) pivotally linked to the first scissor (13), a first lever (10) pivotally linked to the first scissor (23) between an extended position for use and a folded position for storage, a second lever (20) pivotally linked to the second scissor (23) between an extended position for use and a folded position for storage, a first handle (40) pivotally linked to the first lever (10) and a second handle (50) pivotally linked to the second lever (20).

2. The foldable pair of scissors according to claim 1 including a retaining device (70) for retaining the first handle (40) in the extended position with respect to the first lever (10).

3. The foldable pair of scissors according to claim 2 wherein the first lever (10) includes a side plate with an end (16), and the retaining device (70) is a strip including an end secured to a side plate of the first handle (40) and a free end (71) for abutment against the end (16) of the side strip of the first lever (10).

4. The foldable pair of scissors according to claim 3 wherein the end (16) of the side plate of the first lever (10) is flat for adequate abutment against free end (71) of the retaining device (70).

5. The foldable pair of scissors according to claim 1 including a retaining device (70) for retaining the second handle (50) in the extended position relative to the second lever (20).

6. The foldable pair of scissors according to claim 5 wherein the second lever (20) includes a side plate with an end, and the retaining device (70) is a strip including an end (72) secured to a side plate of the second handle (20) and a free end (71) for abutment against the end of the side strip of the second lever (20).

7. The foldable pair of scissors according to claim 6 wherein the end of the side plate of the second lever (20) is flat for adequate abutment against free end (71) of the retaining device (70).

8. The foldable pair of scissors according to claim 1 including an elastic element (30) compressed between the first and second scissors (13; 23).

9. The foldable pair of scissors according to claim 8 wherein the elastic element (30) is a helical spring.

10. The foldable pair of scissors according to claim 9 wherein the first scissor (13) includes an extension (151) received in an end of the helical spring (30) and the second scissor (23) includes an extension (251) received in an opposite end of the helical spring (30).

11. The foldable pair of scissors according to claim 1 wherein one of the first and second scissors (13; 23) includes a shoulder (131) formed thereon and the other one of the first and second scissors (23; 13) includes a strut (24) pivotally linked thereto for abutment against the shoulder (131), thus locking the first and second scissors (13; 23) in a closed position.

12. The foldable pair of scissors according to claim 1 wherein one of the first and second scissors (13) includes a shoulder (132) formed thereon and one of the first and second levers (10) includes two side strips and a back strip formed between the side strips, wherein the back strip includes an end (17) for abutment against the shoulder (132).
